(19) United States
(12) Patent Application Publication
(10) Pub. No.: US 2026/0329571 A1
(43) Pub. Date: Oct. 22, 2026

(54) AUTOMATED CHANGE MANAGEMENT SYSTEM AND METHOD

(71) Applicant: THE PNC FINANCIAL SERVICES GROUP, INC., Pittsburgh, PA (US)

(72) Inventor: Brett E. Spengler, Pittsburgh, PA (US)

(21) Appl. No.: 19/184,521

(22) Filed: Apr. 21, 2025

(51) Int. Cl. G06F 8/65

(52) U.S. Cl. CPC G06F 8/65

(57) ABSTRACT

An automated change management system is described herein. The system may include one or more components and may carry out one or more methods and/or sub-methods. The goal of the systems and methods may be to change one or more compute instances or networking equipment that are part of a larger organization's information technology infrastructure. Communication is an integral component to ensuring appropriate logs and records are kept regarding such changes.

### BACKGROUND

In a network of computers, one or more computers in the network may require software fixes, updates, modifications, or the like. For example, a common scenario in a large network of computers may be that a set of computers within a network are using a specific application, and the author of that application has issued an update that must then be installed on each computer within the set of computers (e.g., patching). Accordingly, there is a need for one or more systems and methods for managing such a process.

### SUMMARY

An automated change management system is described herein. The system may include one or more components and may carry out one or more methods and/or sub-methods. The goal of the systems and methods may be to change one or more compute instances or networking equipment that are part of a larger organization's information technology infrastructure. Communication is an integral component to ensuring appropriate logs and records are kept regarding such changes.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A illustrates an example architecture of an ACMS and related components.

FIG. 1B illustrates an example of a user equipment (UE).

FIG. 2 illustrates an example overview of a change process.

FIG. 3 illustrates an example of a process flow for a change system.

FIG. 4 illustrates an example overview of the patch bundle creation process.

FIG. 5 illustrates an example overview of a change scheduling process.

FIG. 6 illustrates an example of change scheduling.

FIG. 7 illustrates an example of a change event process.

FIG. 8 illustrates an example of an AI agent integrated with an ACMS.

FIG. 9A, FIG. 9B, FIG. 9C, FIG. 9D (collectively referred to as FIG. 9) illustrate an example of an API call to an external server as part of the ACMS process.

FIG. 10 illustrates an example form for detailed information for a change (e.g.,

FIG. 11 illustrates and example of Ansible code that PUT calls Comments' from an external server to a service and/or sub-process of the ACMS.

FIG. 12 illustrates an example JSON message from an orchestration/automation tool to ITSM of a job's failure.

FIG. 13 illustrates an example JSON message from an orchestration/automation tool to ITSM of a job's success.

FIG. 14 illustrates an example of a flow diagram and hardware topology.

### DETAILED DESCRIPTION

As described herein, there are one or more devices, methods, and/or systems for managing and documenting changes in large-scale computer networks; collectively, this may be referred to as an automated change management system (ACMS), or system for short. Changes, as referenced herein, may include patching, updating, downgrading, fixing, modifying, backing up settings/configurations/data, taking snapshots, and/or the like, to networked devices, such as network equipment, computer instances, servers, databases, virtual machines, docker containers, applications, etc. Changes, patching, updating, downgrading, fixing, modifying, backing up settings/configurations/data, and/or taking snapshots may be interchangeable with each other as described herein, unless otherwise specified.

In legacy systems, changes (e.g., patches, etc.) to networked devices may not have been automated, and may have been deployed inconsistently, such as based on an (e.g., arbitrary) deployment schedule for a large organization (e.g., where one or more devices operated by the organization require changes, such as patching).

An automated change management system (ACMS) may have several advantages over legacy systems, such as the rapid response to security threats, the minimization of operation disruption (e.g., when a change is needed), enhancement of flexibility and scalability, adaptation to improvements, adaptation to regulatory requirements, compliance with regulations, management of risk, resource management, data insurance, improvement of performance, and/or the like.

For example, an ACMS that performs patching may enable a swift response to an emerging security vulnerabilities. Cyber threats evolve quickly, and new vulnerabilities may be exploited within hours or days of being discovered. An ACMS may deploy fixes rapidly, minimizing the window of exposure to potential attacks and thereby protecting sensitive data and systems from breaches, malware, and other malicious activities.

For example, an ACMS that performs changes may include the process of patching; patching may address issues related to or concerning security vulnerabilities, software bugs, and/or performance issues/improvements at a software and/or hardware level, through a structured (e.g., sometimes automated) process of assessment, testing, deployment, monitoring, and documentation. Patching may ensure the integrity, security, and functionality of IT infrastructure in a corporate environment, optimizing resource utilization and minimizing operational disruptions.

For example, an ACMS that performs changes may include modifying the available resources (e.g., capacity, storage size, RAM, assigned processors, compute, bandwidth limitations, access rights, etc.). In some instances, changes may include backing up or taking a snap shot of a set of computer instances.

For example, an ACMS that performs changes may include, but is not limited to: updating software; reverting software to an earlier version; decommissioning a server; adding capacity to a server; patching browser vulnerabilities; performing auditing (e.g., so if there is a P1->need to create a change record, then the automation is done in a way that maintains or creates artifacts needed for regulatory reporting). The ACMS may manage the complexity of a change process across diverse systems by using more than one means of implementation (e.g., different components to the ACMS) and phased rollouts, dynamically or periodically, depending on configuration. This approach may avoid operational disruption. In one instance, a change may be required for a feature of an application (e.g. a micro or sub-application).

For example, an ACMS may integrate seamlessly into existing workflows, allowing changes to be applied with minimal downtime or interruption to operations. This is particularly important in large organizations/corporations where prolonged downtime can lead to significant financial losses and productivity issues. The dynamic nature and smart automation may ensure that updates or changes are rolled out in a manner that is least disruptive to end-users and an organization.

For example, an ACMS may be configured to be flexible and scalable, accommodating the diverse and growing needs of a large organization. This flexibility ensures that the patching process can adapt to different types of systems, applications, and configurations without requiring extensive customization or manual intervention. Scalability is essential for maintaining consistent security and performance standards across an expanding IT infrastructure.

For example, an ACMS may support a continuous improvement model, where feedback from a test or from a deployment may be automatically analyzed to repeat and/or correct a future process. This iterative approach ensures that the system evolves to meet changing requirements and incorporates the latest best practices in cybersecurity and IT management.

For example, there may be regulatory standards and compliance requirements that mandate timely recordation of all changes to critical systems. An ACMS ensures that an organization can meet these requirements consistently, avoiding potential fines and legal repercussions. Additionally, the ACMS may support comprehensive risk management by ensuring that critical vulnerabilities are addressed promptly, thereby reducing the overall risk profile of the organization.

For example, an ACMS enables proactive identification and resolution of potential issues before they escalate into major problems. This proactive stance is critical in maintaining the stability and reliability of IT systems, ensuring that performance issues and bugs are addressed as soon as they are identified.

By minimizing disruptions and maintaining system performance, an ACMS may contribute to a better user experience. Users may benefit from more reliable and secure systems (e.g., increased uptime).

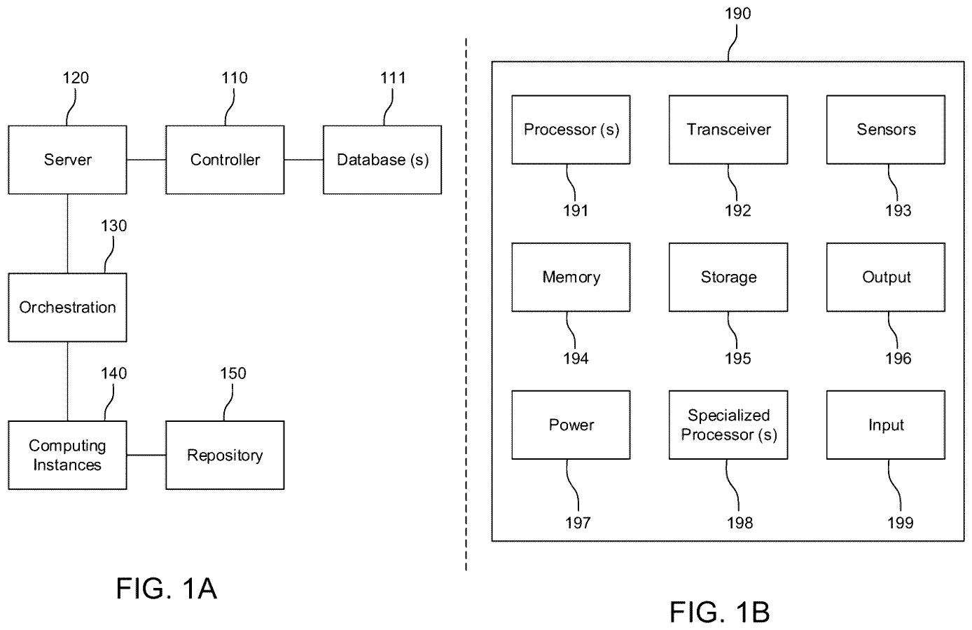

FIG. 1A illustrates an example architecture of an ACMS and related components. As shown, there may be a controller 110. The controller 110 may be operatively connected to a database(s) 110. In one instance, not shown, the controller may include the database(s). The controller 110 may interact with, include, or be a part of server 120 (e.g., IT service management component); this server may facilitate communication between a compute instance (e.g., in the cloud) and on-premises or private network resources (e.g., such as those managed by the ACMS). The server 120 may interact with and/or include an orchestration/automation tool 130 (e.g., AWX, ansible, automation component, etc.). The orchestration tool 130 may then interact with a set of one or more computing instances 140 (e.g., a networked device, a part of the network itself, something that would be changed, etc.). In one instance, a change may need source information, and the computing instances 140 may interact with a repository 150 (e.g., if the change is a patch, then the patch may be scripted to pull an update from a repository, etc.). In some cases, all components may be operated as one system (e.g., ACMS). In some cases, one or more components may be external to a controlling system and/or a network of the controller of the ACMS. In some cases, one or more components may be part of cloud infrastructure.

In some instances, the controller may include an AI component (e.g., server running a machine learning algorithm, large language model, AI chat bot, AI agent, AI entity or the controller may be operatively connected to an AI component (e.g., not shown in FIG. 1A).

In some instances, a server (e.g., server 120) may perform an action (e.g., in the process of implementing a change) or integration needs to run behind the firewall—such as discovering local infrastructure, running automation scripts, or connecting to systems that aren't directly accessible from the public internet. In one case, a MID Server may act as a “bridge” or “agent” that lets an orchestration component (e.g., ITSM, ServiceNow, etc.) orchestrate tasks securely within an internal network; this is not a requirement, but an example of one implementation for the ACMS. Generally, an orchestration component may make any in bound or out bound calls. In one case, there may be a component, such as a part of the ACMS, such as a change management platform, an IT server management (ITSM), and/or some other component of ACMS that would execute directly/indirectly from the platform.

In some instances, the automation tool may perform a change (e.g., patch installations, etc. by securely connecting to the target computing instance (e.g., over SSH for Linux systems or WinRM (Windows Remote Management) for Windows systems, etc.). Because the tool is agentless, in one case, there may not be a separate agent software to install on computing instance. Instead, the tool may use the credentials and connection details defined in an inventory file (e.g., other dynamic inventory sources)(e.g., as part of the instructions from the controller) to establish the remote session. Once connected, the tool may execute instructions found in a “playbook”—a YAML file that outlines the exact tasks to be performed. For example, for installing patches, these tasks might involve using modules designed for package management (e.g., yum or apt on Linux) or modules that manage Windows updates. The tool may gather and return results of each step, allowing for detailed reporting (e.g., including whether the patch was successfully installed).

An ACMS may comprise of one or more smart functions/automations/AIs/modules/models/algorithms/logic/etc. that run on one or more pieces of hardware, as further discussed herein. The hardware and software may perform the changes by interacting with various components as needed, as described herein. The ACMS may be specialized from a hardware/software perspective to meet operating requirements (e.g., legal, efficiency, power usage, etc.). The ACMS may have one or more of the following operating requirements, such as but not limited to: a network interface; a user interface; two 12 node clusters (e.g., one instance for each cluster), where each node is, for example, 12 CPU 64 GB of RAM (e.g., minimum requirements may be 4 CPU 8 GB of RAM), and where the compute nodes connect to a postgresql database, and there may be at least one database per cluster. In some cases, one or more components of the ACMS (e.g., FIG. 1A, and/or other components described herein) may be within the same network, part of a cloud infrastructure, and/or part of different networks.

In some cases, AI may be referred to herein and may be interchangeable with large language model, machine learning, AI agent, AI chat bot, AI service, AI component/sub-component, etc. The ACMS may utilize AI functionality to enhance the process of implementing a change (e.g., at one or more points in the method/work flow of carrying out a change). The deployment of an AI service may require a hardware and software architecture to support model training, inference, and integration with the ACMS. At a high level, an AI service architecture may multiple layers: a hardware layer, a software framework layer, and an application layer. The hardware layer may include high-performance computing resources, such as GPUs (Graphics Processing Units) or TPUs (Tensor Processing Units), which are optimized for deep learning workloads. Additionally, CPU clusters may be used for general computations and lightweight inference tasks. Storage solutions, such as distributed file systems (HDFS, S3) or databases (PostgreSQL, MongoDB, or vector databases like FAISS), store model weights, training data, and inference results. The software framework layer may comprise machine learning libraries and/or model-serving solutions, including TensorFlow, PyTorch, ONNX Runtime, or TensorRT, which facilitate model execution. AI models may be deployed using model-serving frameworks, such as TensorFlow Serving, TorchServe, or FastAPI-based custom services. Finally, at the application layer, AI services may be exposed via APIs (REST, gRPC), microservices, or embedded in broader software platforms, enabling integration with client applications, whether web-based, mobile, or enterprise systems.

In some cases, the AI service may be deployed internally, and may be hosted within the same network as the ACMS, or as part of the ACMS, or within a private cloud environment that is functionally part of the ACMS by separate. The AI model may be managed as a microservice, where an internal API facilitates requests from other internal components, functions, or applications. For instance, an organization deploying an AI-powered reporting/log process (e.g., part of the ACMS process) may host the model on an internal Kubernetes cluster, using NVIDIA GPUs for accelerated inference. The service may be exposed via an internal API gateway, with authentication handled through LDAP or IAM (Identity and Access Management) policies. The data pipeline may rely on ETL (Extract, Transform, Load) processes, leveraging Apache Kafka for real-time data streaming and a PostgreSQL database for structured metadata storage. Monitoring and logging may be managed using Prometheus and Grafana and/or their equivalents, ensuring visibility into system performance and resource utilization. This architecture may ensure that sensitive data remains within the organization's network while allowing seamless integration with existing enterprise applications.

Additionally/alternatively, an externally deployed AI service may operate as a publicly accessible API, where the ACMS may interact with the model over a an external network (e.g., internet, private VPN, etc.). In an example, there may be an AI-powered chatbot service serving as an entity within the ACMS process/system, which receives API calls from client applications (e.g., a component of ACMS, step in the process, etc.) and returns responses in real-time. This architecture may be hosted on cloud-based AI platforms like AWS SageMaker, Google Vertex AI, or Azure AI Services, leveraging auto-scaling GPU instances to manage varying workloads. Requests may be processed through an API gateway (e.g., AWS API Gateway, Kong, or Apigee), which handles authentication, rate limiting, and load balancing. AI inference may be performed in a serverless or containerized environment, such as Dockerized microservices running on Kubernetes (EKS, GKE, or AKS), allowing efficient scaling. Data persistence may be managed using cloud-native storage solutions (e.g., AWS S3, Google Cloud Storage, or Redis for caching responses), while observability may be maintained through monitoring tools (e.g., part of ACMS or external), such as AWS CloudWatch or Datadog. Security mechanisms, including OAuth, JWT-based authentication, and encryption, may be employed to ensure that users can access the service safely.

FIG. 1B illustrates an example of a user equipment (UE). A UE may be interchangeable with any device and/or hardware referenced herein (e.g., computing instance, computer, server, network device, etc.). As shown, a UE may include, but is not limited to, one or more of the following: processor 191, transceiver 192 (e.g., wireless receiver and/or transmitter, wired communications port, radio transceiver, light transceiver, etc.); sensor 193; memory 194; storage 195; output 196 (e.g., display, module to provide web interface, graphical user interface engine, etc.); power 197 (e.g., battery, or connection to an external power source); specialized processors 198 (e.g., ASIC, GPU, TPU, NPU, etc.); and/or input (e.g., keyboard, touch screen, web interface input, SSH, port, etc.).

In one example, changes may be made to a computing instance. As described herein, a computing instance may comprise of at least part of the resources of a processor, memory, and/or storage of a computing device. A computing instance may be a UE, computer, laptop, virtual machine, smart phone, networked device, network hardware, server, host computer, etc. The computing instance may run software, that runs on hardware, that needs patching. For example, the hardware may include one or more of the following, which may be operatively coupled (e.g., directly or indirectly): motherboard; CPU; power source; power backup; memory (e.g., RAM); storage (e.g., SSD, HD, etc.); networking interface and/or communications interface (e.g., RJ45, SFP, Fiber, etc.); operating system; redundant or backup components; and any other similarly related components (e.g., as described herein). A computing instance may also comprise of a portion of a server, and/or one or more servers. A patch may be applied to a computing instance, and/or software running on a computing instance, and/or one or more servers.

Generally, the infrastructure of an organization may be organized into sets of computing instances depending on the desired uses and functions, where for a given set specific software may be installed and maintained that is specific to the uses and functions of a line of business of the organization. A line of business (LoB) may be interchangeable with a set of computing instances associated with a department, a mnemonic, and/or generally a set organized as such for management purposes, that require management. The performance of a set of computing instances may be variable, due in part to the ability to scale (e.g., up or down) resources, processing power, and/or other aspects of computing, in order to maximize the use of the inherent limitations of the underlying physical computing infrastructure. The scalability of these computing instances may be a part of the management of these computing instances (e.g., a function of the ACMS, as further described herein). The ACMS may manage changes for an entire a one or more sets of computing instances, networked devices, etc. (e.g., all or a selected set of an organization/company). For a given organization there may be inner API and outer API's, where each API is run on a container and is dedicated to a set of computing instances.

A set of computing instances may be organized based on a common utility, related to the manner in which the computing instances operate, the access the computers provide, and/or performance/resources that are allocated to a given set. Accordingly, an ACMS may determine what to patch and when to patch (e.g., with change controls within a given patch cycle, as further described herein) for a one or more sets of computing instances. A set of computing instances may be organized based on location, access level, user group, etc.

For one or more sets of computing instances, there may be at least one ACMS. An ACMS may comprise of one or more components, operating in concert with one another (e.g., physically separate, physically combined, operatively connected, virtually combined, and/or virtually separate as in different software components, as further described herein). In some cases, there may be more than one component within the ACMS (e.g., entities, or more than one computing instances of the ACMS itself that orchestrate a patching process). In some cases, an ACMS may have clustered compute nodes that are connected to a shared database (e.g. CMDB, etc.).

In one embodiment, an ACMS may be directed toward deploying patches; such a use case is intended to be an illustrative example, and it is intended that patching may be generally substituted for one or more other change types (e.g., and tailored as technically appropriate) as described herein.

An ACMS may conduct vulnerability assessments to identify software and computing instances requiring patches. There may be risk evaluation protocols, utilized by the ACMS, that prioritize patches based on the severity of vulnerabilities, considering factors such as potential data breaches, malware infections, and system integrity threats.

In one instance, patches may be initially applied within a sandbox/test environment to verify operational stability and to prevent disruptions in production systems. A sandbox environment may be selectable by the ACMS as a set of computing instances separate from computing instances operating essential functions for an organization. Compatibility testing may ensure that patches do not interfere with existing software and hardware configurations, maintaining system coherence.

Deployment of patches, as part of a patch process, may include a phased rollout to mitigate risk (e.g., a subset of a set of computing instances, and/or a super set of computing instances in an organization). A patch process (e.g., implemented by the ACMS) may be used to streamline the distribution and installation of patches across multiple systems, reducing manual intervention and increasing efficiency.

Post-deployment (e.g., of a change or patch, etc.) monitoring (e.g., performed by, or information sent to the ACMS, etc.) may be conducted to detect any issues arising from patch application. Further, there may be verification processes to confirm that patches have been successfully applied and that the intended vulnerabilities or bugs have been addressed.

Comprehensive documentation and records may be maintained (e.g., by the ACMS, and/or a separate entity operatively coupled to the ACMS) detailing the changes that are applied, the timeline of their application, and the details of the systems/UEs affected. As discussed herein, documentation, records, audits, and/or logs may be interchangeable, unless otherwise indicated. This documentation may support compliance with industry regulations and standards (e.g., potential external review/audits, internal review, or regulatory requirements), ensuring that a change process meets all relevant security and operational requirements (e.g., for a given organization/company that may be under such scrutiny). In one instance, each step of a change process may have a log entry. In one instance, a log entry may be made for a select group of steps of a change process; the select group may be manually configured, pre-configured, and/or dynamically determined based on context of additional information. For example, an AI model/engine (e.g., part of, or external to, the ACMS) may be provided a regulation or policy, and based on the analysis of this generate a configuration for logging for a new or modified change process (e.g., associated with the regulation or policy). The ACMS may include a real-time audit (e.g., manual, AI agent, etc.) is aware of the status of future, in-progress, and/or completed/failed change processes. For example, the logs being generated may be analyzed in real-time and/or at a configured time. In one instance, only the logs may be reviewed. In one instance, a sub-process of the ACMS may be a real-time audit which requests/monitors/receives information from other parts of the ACMS (e.g., separate from the logging process, or before the logging process). In one instance, documentation and records may also be referred to as change records (CR). The ACMS may produce CRs may follow a given change process and comprise all/some related documentation/logs. The CRs may be essential to adhering to policies and/or regulations. In one case, an error with a reporting step may cause a change process to shut down due to the need to log all aspects of a change process (e.g., if a log cannot be created, then CR would be incomplete, therefore a change process would have to stop and/or need to be produced manually after the fact). In one case, an error with a reporting step may cause a change process to send a notification. In one case, an error with a reporting step may cause a change process to cause an audit after the change process is complete in order to complete the CR (e.g. instead of it being logged during of the change process).

The ACMS may be configured and/or accessed through one or more interfaces. The interface may receive input, such as details regarding a given change. The input may be received from an entity, such as another computerized system (e.g., automatically, an API call, message, AI agent, etc.), or from a user. The input may only be received from an entity with sufficient access and/or privilege (e.g., collectively referred to as rights), in order to limit, control, and document the implementation of a given change. The rights of a computerized system may be an automated script, an artificial intelligence, and/or some other entity capable of generating a change message.

For example, for a given change, input may be required regarding one or more servers that may be effected by the change, which either run computer instances with software, or host the software itself that needs to be changed.

For example, for a given change there may be a payload that depends on the nature of the change. For example, in an instance where a change is scaling resources, the change may include instructions to adjust and/or configure a computing instances resources (e.g., allocate more cores of a processor to a given computing instance). For example, in an instance where a change is updating software, the change may include a file to be installed on a given computing instance (e.g., to replace an existing software version, or augment an existing software with additional libraries, etc.).

For example, for a given change there may be input required of data relating to the payload, such as a date or time, a schedule, a periodic recurrence, non-periodic but rule-based recurrence, dynamic, and/or trigger events.

For example, for a given change there may be input of a target system. Additionally/alternatively, there may be input of a target software, and the ACMS must determine the target system. Additionally/alternatively, there may be input of related systems. Additionally/alternatively, the controller may determine related system based on other input.

For example, there may be input concerning details of the creation of one or more records relate to the change, such as records that are required for the change at some point in the change process (e.g., proof of authorization, documentation, results of sand box testing, etc.).

For example, the ACMS may push changes to network switches, decommission servers, take virtual machine snapshots and/or add capacity. ACMS may accomplish this through automated orchestration with change management.

Once the input has been received, the ACMS may determine blackout times with the related system (e.g. target of the change). For example, the ACMS may interface with that computer system (e.g., server, set of computing instances, etc.) and restrict access to the system, notify users of the system, and/or the like. In some instances, other systems may also be contacted and configured, where the other systems may be systems that may be effected by the change, as determined by the controller. A notification may comprise of a message sent via one or more means, such as a pop-message, an email, a text message, a configuration file, a post to a virtual shared space (e.g., website, internal message board, etc.), and/or the like.

At the configured time, the ACMS may implement the change. Depending on the change, this may include one or more steps. For example, the controller may send an message to begin the change process (e.g., an ansible message to AWX, such as an API REST call). A change process may reach an end state with varying degrees of success (e.g., successfully, semi-successfully, not successfully, etc.). For example, a change may be successful if a piece of software and or a server OS is successfully updated to a different version. For example, a change may be unsuccessful if the update is not successfully applied. In one instance, an error message may be provided if a change is unsuccessful. These successes or failures may have different types, such as relevant to a specific outcome. For example, a change may be for updating to a specific version. Regardless of the outcome, at the end of a change process, the entire process regardless of outcome may be documented in some or all of its detail. [ ]

If the change process is incomplete and results in a failure, an end report may be created with details of the failure. Subsequent to a failure, an automatic (e.g., preconfigured or dynamically determined by an AI agent of the ACMS) or manual action be the re-attempt at performing the change. The re-attempt may be the same change or it may be modified as a result of the failure. The change process may be specific to the specific type change. The change process may be configured at the time of inputting the change.

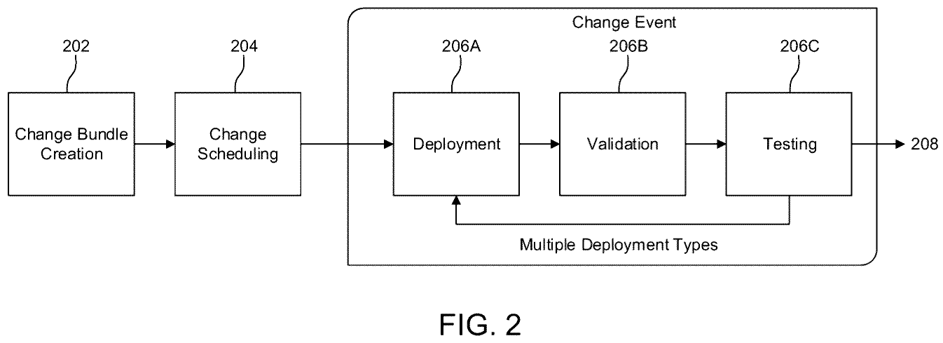

FIG. 2 illustrates an example overview of a change process. At 202 a change bundle is created (e.g., from one or more changes, etc.); the bundle may be a set of changes, comprising of one or more changes. At 204 the change process is scheduled (e.g., for the patch bundle); scheduling may be automated, and take into consideration one or more parameters that were input as part of the patch bundle creation, and/or known to the ACMS. At 206 the change event is processed. The change event comprises of the deployment, validation, and in some instances testing. In some instances the testing may revert through the change event process several times, depending on the results of the testing. In some instances, the entire change event process may repeat itself, depending on the nature of the change. In one instance, updating software to a version that is several versions ahead of a current deployed version of the software may require repeating of the change event process (e.g., if each update needs to be applied prior to the next). At the end of the change event process 208, there would be an end state, which may include finalizing the process (e.g., sending notifications of the result of the change, auditing the process, ensuring logs are complete, repeating the process, modifying the process to attempt again, etc.). In one instance, the testing would not be conducted or would be optional.

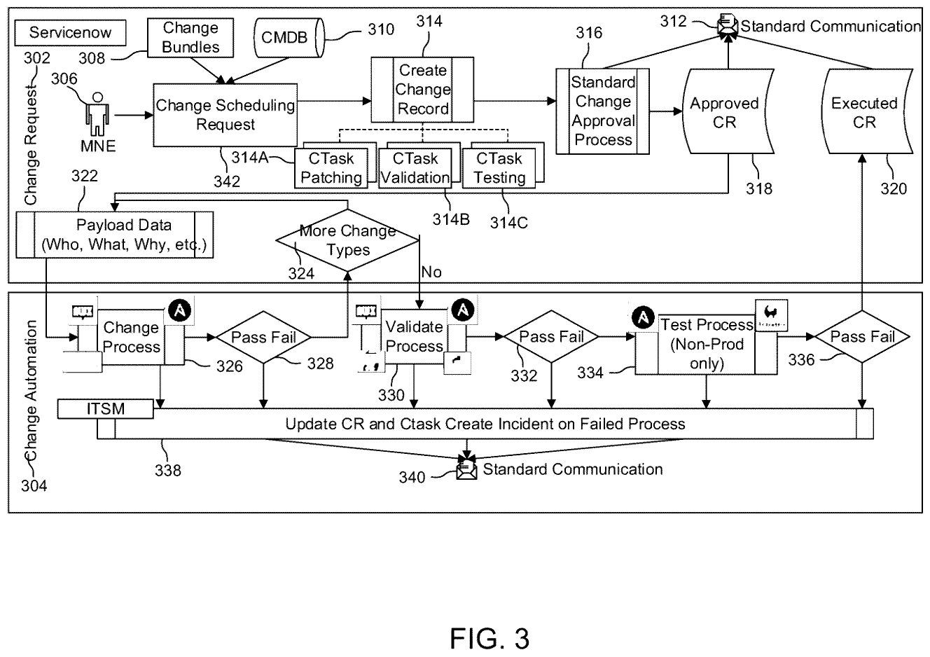

FIG. 3 illustrates an example of a process flow for a change system. As illustrated, there may be an ACMS or multiple components to an ACMS that implement a change process. For example, at 302 there may be a change request portion of a change process. At 304 there may be a change automation portion of a change process. A change request may be input via another automated system, as described here in, or a user. For a given change request, starting at 306, there may be a change scheduling request via a specific interface system (e.g., an ITSM front end, with custom form requests). A change request may pull from information from a change bundle, a configuration management database (CMDB) (see 308 and 310), and/or other input as described herein.

For each change there may be a change record 314, and a resulting change task for the change record 314A, 314B, and 314C. In some instances, there may be change approval process 316. In one instance, the change approval may be automated depending on the detailed input as part of the original change request. Additionally/alternatively, the change approval may result in further communication 312, as described here in. In one instance, the change approval may result in an approved change request 318. As discussed herein, a change (e.g., at this point in the change process) may be called a change request, but this nomenclature is not intended to be limiting, but merely illustrative of an example where the change results in some change.

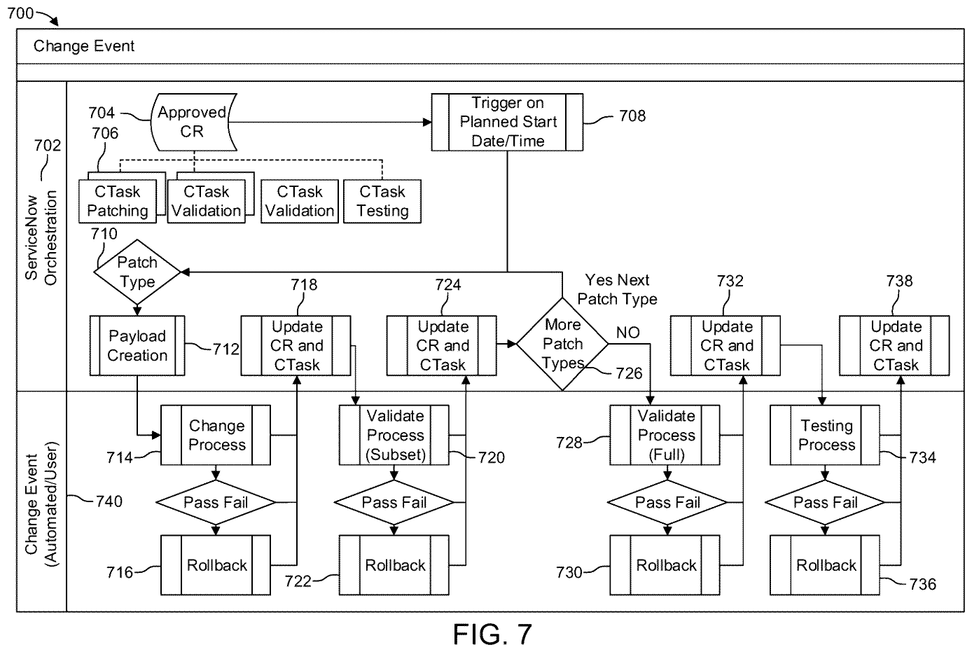

The approved change request at 318 may then proceed to the payload data of a change request (e.g., the details of the change, such as a patch, may include what patch to apply, where the patch needs applied, and the why (change record number), etc.). In one instance, The When may be immediately upon CR approval, or triggered at the date/time selected during scheduling (e.g., at 342). FIG. 3 at 322 could then be referenced in para 0050. FIG. 7 at 708 shows correct.

In one instance, for example, the message from the change request to the change automation may be a JSON payload (e.g., from ITSM->AWX). This message may comprise (e.g., 322), but is not limited to, the who (server names), the what (what to deploy; oracle patches, linux patches, software to install, VM to add capacity, etc.), and the why (change record number). On some occasions more information may be needed from the CMDB. For example, If rerunning a failed job, the job might query the CMDB first to ensure we're still within the “change window” start and end date/times. During a server decommission the CMDB may be queried to get one or more parameters, such as an IP address, serial number, desired operational state, whether it is a virtual or physical server, what vcenter it resides on, etc.

Change automation 304 may comprise several automated steps, some of which are illustrated in a specific example, however the illustration is not intended to limit the flow the change process, and it is intended that one or more of the illustrated processed may be changed, removed, reordered, duplicated, etc. With the information from the payload data 322, the change process 326 may begin, which may result in a pass or fail. In one instance, the flow may check for more change types for a given change request 324, and may return to retrieve more information at 326, proceeding as described previously. In one instance, after the change process 326, a validation process may take place 330. The validation process may pass or fail 332. In some instances, there may be a testing process 334; while illustrated after the change and validation process, this may be prior to the change process. The test process may pass or fail. In one instance, testing may not be conducted or may be optional. In one instance, a determination may be made if testing is necessary based on one or more factors, such as the source of the change/modification/patch, preconfigured approvals/authorizations, etc.

In some instances, depending on the result of the change process, the change request may result in a number of flows, such as 338 updating a change request and/or a change task based on the failure of a given process. This may result in further communication 340. Additionally/alternatively, the change process may flow to the completion of an executed change request 320 and result in communication 312.

As described herein, communication (e.g., standard communication as referenced in FIG. 3) may include one or more messages sent via a platform or service, such as but not limited to email, SMS, service specific communication forms (e.g., internal messaging app, external messaging platform, etc.). The one or more messages may serve as the trigger event for one or more steps and/or automations, as described herein. In some instances, the one or more messages may require a response message in order to proceed to another step, where the response message may be an automated message (e.g., a computer entity different than the controller makes a determination based on the contents of the message and responding with an answer, or further instruction), and/or a user message. In one example, a message and/or communication may include email, and/or capability to integrate with messaging systems (e.g., Microsoft Teams, Mattermost, Slack, etc.) for notifications, such as task successful completion or failure.

A change management system may involve multiple communication events to ensure the system maintains proper records and logs, as well keep stakeholders informed of important statuses. Communication may occur, for example, upon the creation of a change request and may continue throughout the change approval process, providing updates on the status and decisions made. When the request process is completed, notifications confirm the finalization of changes. If a process fails, an incident is created to alert relevant teams. Standard tools and processes used for communication include email, SMS, and or other forms (e.g., MatterMost, teams, slack, etc.), ensuring timely and efficient information sharing. Additionally, there may be a monitoring component that may monitor key steps in a change process, like version changes, failures in a change process, and/or other such events as described herein.

AI may enhance the communication aspects described herein by automating and optimizing communication workflows. AI-powered chatbots or virtual assistants may send real-time notifications, summarize change request updates for stakeholders (e.g., pre-configured users or other smart entities such as another chat bot or AI agent), and provide proactive alerts about potential issues. Machine learning algorithms may analyze incident patterns to predict failures before they occur, triggering preemptive or changes in the execution of a change process. Natural language processing (NLP) may categorize and prioritize change requests, communications, incidents, etc. thereby reducing manual effort. AI-driven analysis on communication channels may also help identify urgency levels and escalate critical issues automatically. Incorporating AI may improve efficiency, reduce response times, and enhance decision-making within the change management system. In one case, an AI component may reside at, triggered, invoked, called, etc. at the point of communication in a given change method (e.g., as described herein). For example, two AI agents may interact with each other if one is triggered to send a failure report, and another receives the failure report and is configured to process the failure report and send recommendations and analysis. These recommendations may be an update to settings stored in the change system. These recommendations may by automatically incorporated into the next and/or related change.

In one example, there is change process (e.g., carried out by the ACMS and/or one or more operatively connected components). A change may be initiated by a request, such as a change request, submitted through a scheduling portal. This request may reference a Configuration Management Database (CMDB) and/or a repository of change information (e.g., sources for updates, etc.) to determine which servers or endpoints should be patched. The request may trigger the creation of a Change Record (CR), which may create a separate change tasks as part of an approval process. Once approved, the change process may proceed, being noted in the change Record. Next, the actual change may be carried out. Payload data (e.g., defining what the change is, who, what, why, etc. as described herein) is fed into an automation platform (e.g., Ansible or AWX), which coordinates the patch process across targeted computing instances (e.g., UEs or computers, software, etc.). Depending on whether additional patch types are needed, the workflow may invoke different patches, validation, and/or testing steps. Each change action may complete with a “pass/fail” status, as well as details about the pass/fail. As patches are successfully deployed or fail, the system may update the Change Record and/or creates incidents reports when tasks fail, where in some instances notifications may be sent as a result of the completion (e.g., email, SMS, chat platforms, logs, etc.) to keep stakeholders informed. Testing processes for non-production environments may be integrated before final deployment to production, ensuring only validated patches are installed. Throughout the process, the system may log and record relevant data, helping maintain visibility and compliance.

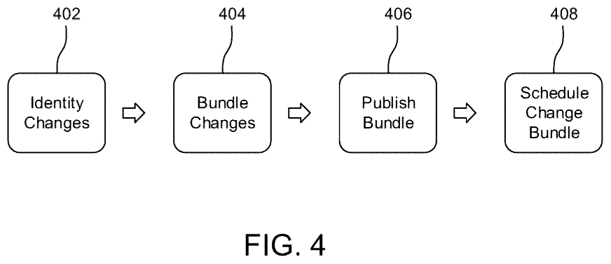

FIG. 4 illustrates an example overview of the patch bundle creation process. Each element illustrated here may be further described in greater detail herein. At 402, changes may be identified. This may be manually entered by a user, an AI agent.

In one instance, changes may be sourced internally. In one instance, changes may be sources from an external repository. For example, vendors who “own” an application may provide a patch and/or software update (e.g., Linux=Red Hat, Windows=Microsoft, Chrome=Google, Firefox=Mozilla, Adobe Reader=Adobe, etc.). In one instance changes may be settings that need to be changed, resources that need to be changed, etc.

At 404, the changes may be bundled together as appropriate (e.g. manually configured, determined based on an algorithm and/or AI model sorting, common basis, etc.). At 406 the bundle may be published. In some instances, this may include a review (e.g., automated or by a user). The review may include a message sent to an entity and a response to the message (e.g., approving the bundle or an aspect of the bundle). In some cases, after publication, the bundle may need to be edited in some way. At 408, the patch bundle may be scheduled.

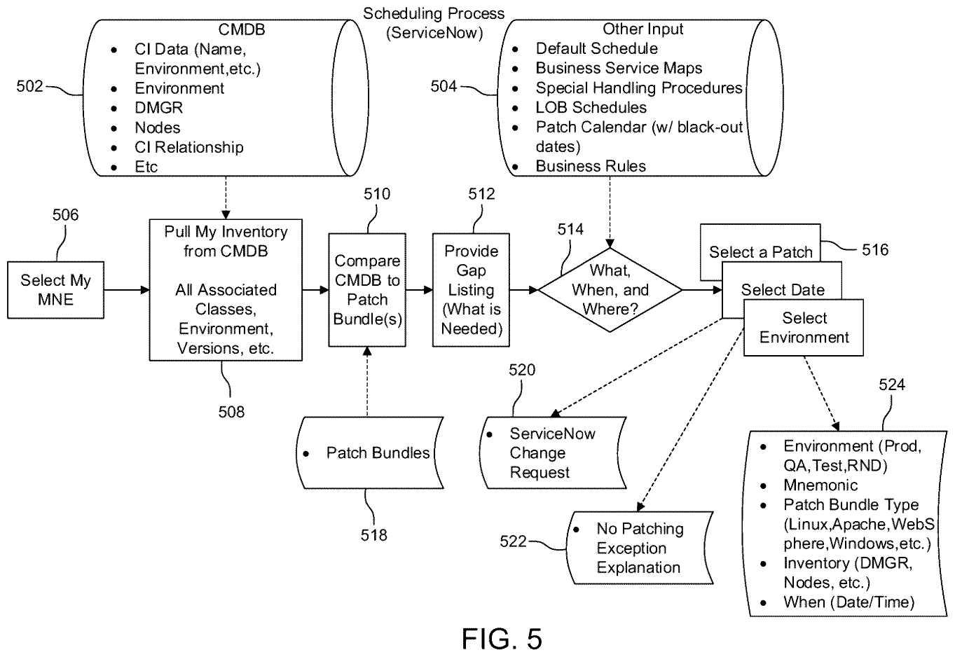

FIG. 5 illustrates an example overview of a change scheduling process. In this example the change is a patch. Each element illustrated here may be further described in greater detail herein. For example, this process may be accessed through an interface provided by the ACMS. At 506 a mnemonic may be selected. At 508 inventory for this from the CMDB 502 may be retrieved. The inventory may include all associated classes, environment, versions, etc. The CMDB 502 may include configuration data such as Configuration Information (CI) data (e.g., name, environment, etc.), DMGR data, environment data, relationship data, node data, etc. At 510, the CMDB data may be compared to a given patch bundle(s). The patch bundles may be retrieved from a patch database 518. At 512 a gap listing is provided, such as what is needed. At 514 additional details are retrieved or input, such as from other input database 504. Other input database 504 may include a default schedule, business service, maps, special handling procedures for specific updates, line of business schedules, patch calendars, with blackout dates, and or various business rules related to the administration and implementation of patches. At 516 patch and a date and an environment is selected for further processing, as described herein (e.g., the implementation of the patch). Included in 516 are possible outcomes and side processes, such as 520 change request, 522 no patching exception explanation, and or details related to the environment 524 (e.g., production, quality assurance, test, RND, Mnemonic, patch bundle type, inventory, when, etc.). In one case, the CDMB may not pull in patch bundles. In one case, the ACMS, internal service, or external service may perform scanning to finding something that is out of compliance (e.g., are all web browsers for a given set of compute instances patched) (e.g., this assessment would not be pulled from the CMDB, and may live elsewhere). In one example, there may be a change specifically for scheduling apache updates, where only servers that have apache on it may be part of the change process. One or more components or steps as shown in FIG. 5 may be optional and/or reordered (e.g., gap list may not be performed).

In one instance, a patch exception may provide information that may be useful in subsequent steps. For example, audits may be performed (e.g., manual, automatic, AI, etc.) periodically and inspect a random set of computer instances to ensure that risks have been mitigated (e.g., patches have been applied regularly and/or in a timely manner); if a set of computing instances are not patched in a timely manner (e.g., within a given time period threshold) a “patching exception” may be provided. In some instances, this may allow for a delay of a patch for a given period of time before another assessment may be needed. In some instances, there may be reasons for a patch not being possible (e.g., no attempt, attempt with failure, etc.), such as a patch might include stability issues of the patch and an updated/revised patch is expected, or a patch requires additional testing (e.g., an application vendor does not recommend upgrading until certification for a given OS, e.g., going from RHEL8.9 to RHEL8.10). The patch exception may provide details and may require an approval (e.g., a documented acknowledgement for the logs).

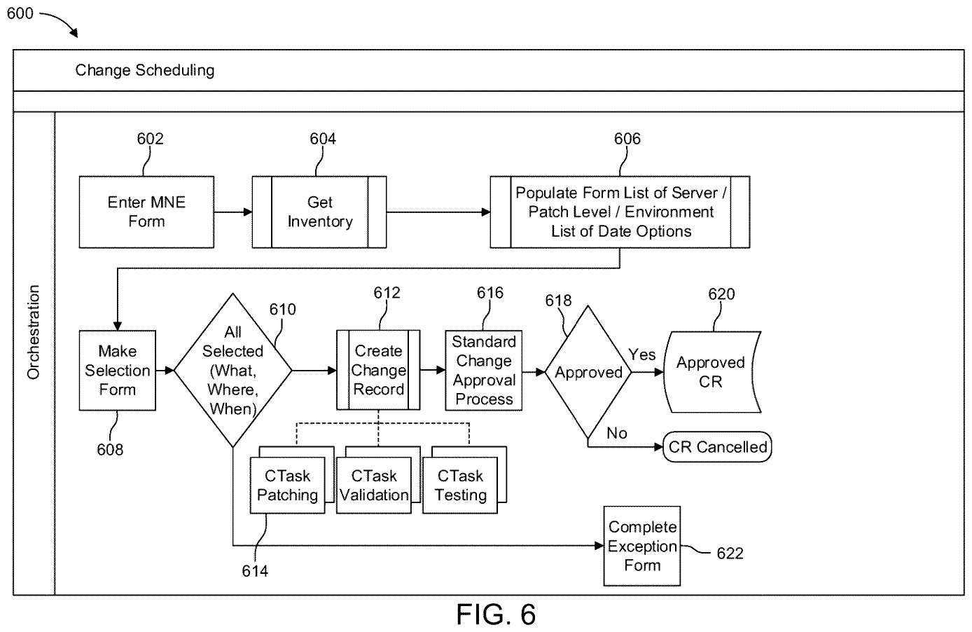

FIG. 6 illustrates an example of change scheduling. At 602 a mnemonic form may be processed. At 604 inventory is retrieved. At 606 details of a change, art determined and populated into another form, where the details may include a list of servers, a change level and environment list of date options and or the like. At 608 particular instance of a form is selected, such as those processed earlier. At 610 changes may be implemented using the information of what, when, and/or where. The implementation may lead to 612 chain creation of a change record. The creation of a change record may also result in 614 a creation task for changing, validating, and testing. At 616 there may be a standard change approval process. At 618, if the change is approved (e.g., a message is sent to an approving entity, and a confirmation is received), then this will result in an approved change record at 620. If the change is not approved, then the change record may be canceled. In some cases, at 622 a change may not be appropriate to implement, and an exception message may be sent. At 624, for each Change Record (CR) there may be an associated MNE, target environment, scheduled date and time, and/or CI. A single CR may include multiple Change Tasks (CTasks). In one instance, the may be one or more patch types, such as include Linux OS patches, Tomcat patches, Apache patches, WebSphere patches, or Server/Application Validation patches. The CIs listed in a CR may represent the full set of patch types and/or specific servers selected by a user or agent for the change window.

In one instance, there may be one change record (CR) for each of exception message. For example, on a given monthly patch cycle set of computing instances may have a separate CR for each environment (e.g., DEV, TEST, QA, PROD). These may be scheduled on different days throughout the month (e.g., DEV->TEST->QA->PROD).

FIG. 7 illustrates an example of a change event process. At 704 there may be an approved change request, which may include 706 change tasks of various types as described here in, such as change, validation, and or testing. From the approved CR 704, at 708 there may be a trigger for a planned start date and time. At 710 the change type is determined. At 712 the payload of the change is created based on the change type. At 714, the change is implemented. The change implementation may either pass or fail. In some instances where the change fails, at 716, the change may be rolled back to a previous version (e.g., in a software update scenario). At 718 the change record and change task are updated based on whether the change passes or fails. At 720 validation process (e.g., a sub validation process) may be implemented. Again, validation process, major result in a pass or fail. If there is a failure, or if the change is not able to be verified for some other reason 722 the changes rolled back. At 724 the change request and change task are updated based on the validation process. At 726 more change types of determined. More change types 726 maybe determined directly from a triggered and plan start date or time. If there are more change types, they are implemented at 712. If there are no more change types, then a full validation process at 728 is performed. At 730, if the validation process fails, then the one or more aspects of the change may be rolled back. At 732, the change request and change task are updated based on the full validation process. 734 in some cases, testing is performed. If the testing fails, then the change may be rolled back at 736. 738 the change can change task are updated based on the testing process.

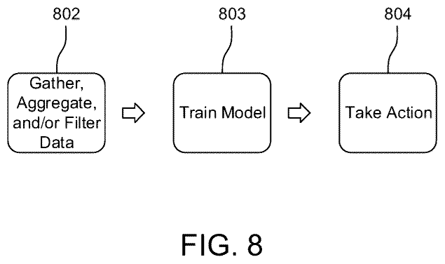

FIG. 8 illustrates an example of an AI agent integrated with an ACMS. Initially, at 802 data may be gathered, aggregated, filtered, cleansed, etc. to use as input for training an AI model for an AI agent. To enable intelligent decision-making within a change automation system, the AI agent may be trained at 803 using the historical data accumulated from data available from the an ACMS. This data may include logs of patch events, detailed error messages, timestamps, pre-and post-change system states, patch metadata (e.g., severity, type, vendor), user interaction data such as overrides or manual interventions, and/or any other data described herein.

Once trained, the AI agent may perform a variety of operational tasks within the patch automation system to enhance reliability, efficiency, and scalability. One change function may be patch risk assessment, where the AI agent predicts the likelihood of a patch failing on a given system based on its configuration, patch history, and environmental conditions. These predictions may inform automated patch deferral, escalation to human review, and/or alternative remediation paths, as further described herein.

Another change function of the AI agent may be patch prioritization, where the agent dynamically ranks patch jobs based on factors such as system criticality, patch severity, historical risk, compliance requirements, and/or current threat intelligence. The agent may perform this function based on change policies and/or configurations (e.g., strategic and risk-aware patch deployment planning, etc.).

The AI agent may process real-time or near real-time data from the ACMS and perform anomaly detection by monitoring system behavior post-change and identify patterns that deviate from expected norms. For automated decision making, the agent may autonomously decide whether to apply, delay, or skip a patch. In the event of known failure conditions, the agent may initiate smart rollbacks by referencing similar scenarios from past data and triggering pre-tested recovery workflows, and/or performing preconfigured operations in the event of certain trigger conditions.

In one case, the AI agent may support natural language interactions with IT staff. For example, an AI agent of the ACMS may receive input from a user, where the AI agent may respond to queries such as “Which servers are most at risk if patched now?” or “What caused the last patch job to fail?”—streamlining incident investigation and planning. By taking on these responsibilities.

Supervised learning techniques may be applied to the ACMS AI Agent, where historical outcomes (e.g., change/patch success vs. failure) serve as labels. For more dynamic and continuous learning scenarios, reinforcement learning or decision-tree-based methods may be used to model optimal patching strategies over time. Additionally, natural language processing (NLP) models may be trained on change/patch documentation, release notes, and/or support tickets to extract context and correlate known issues with specific patches or system configurations.

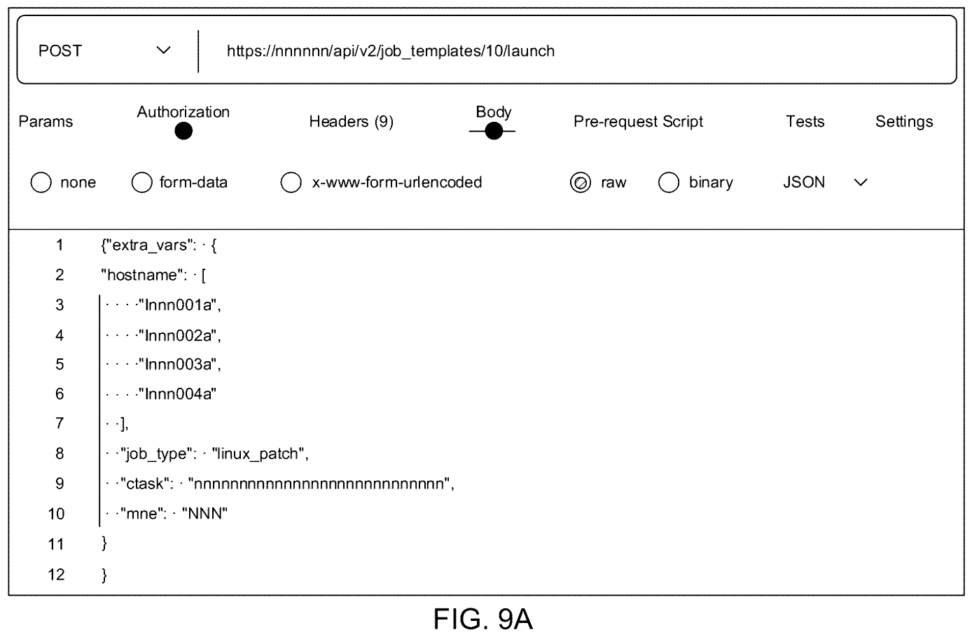

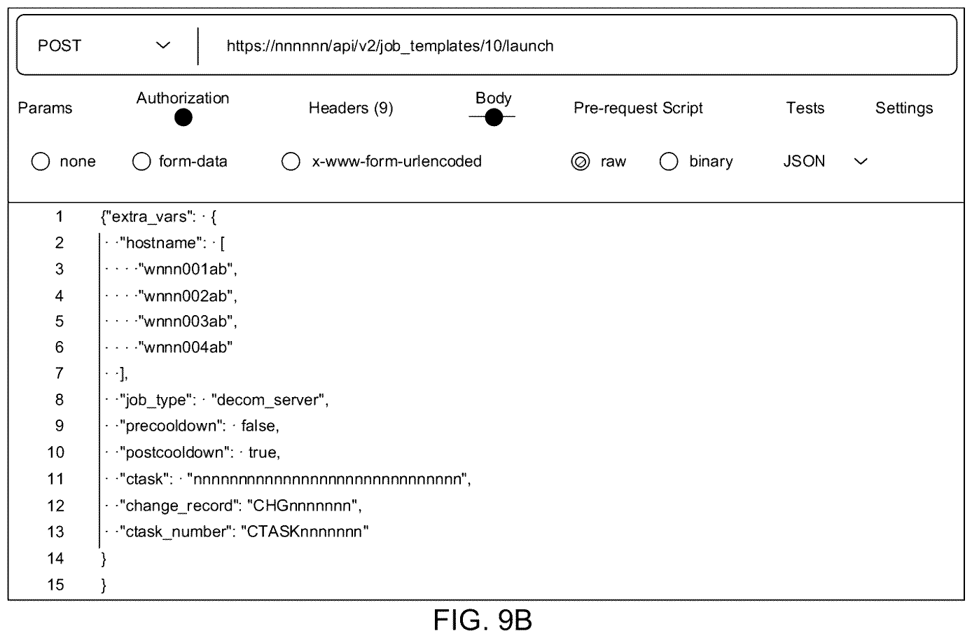

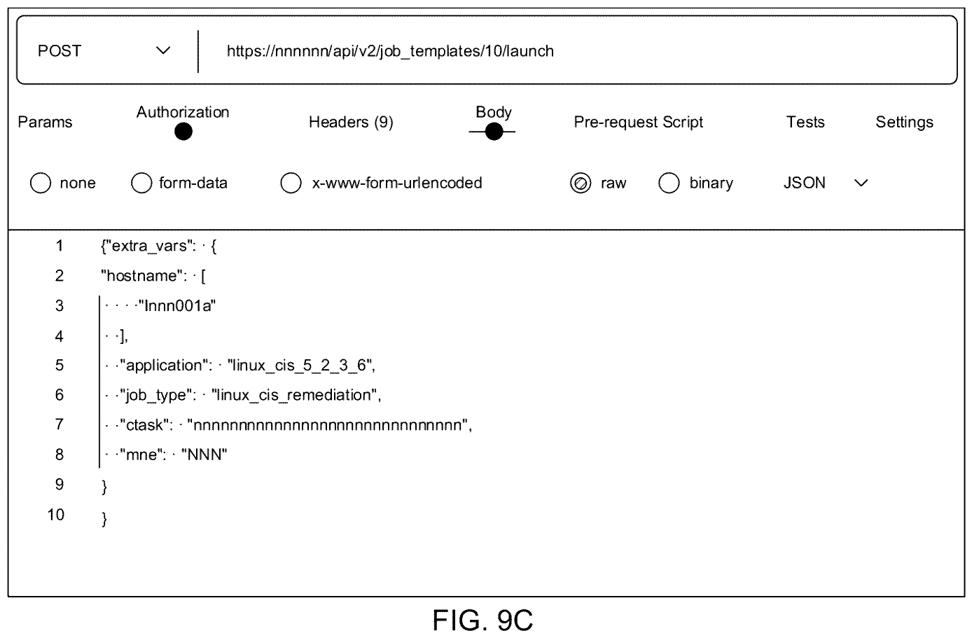

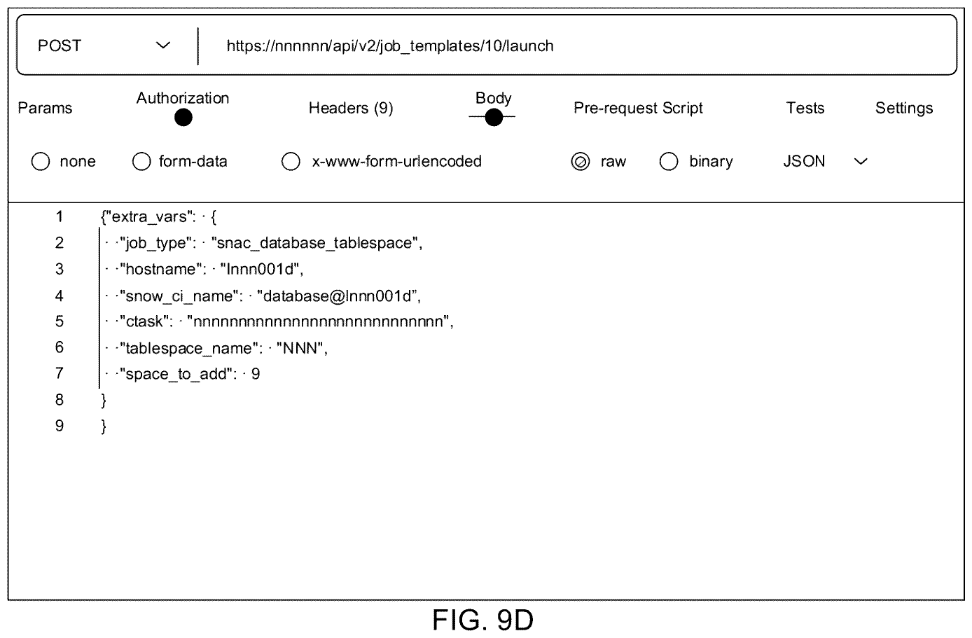

FIG. 9A, FIG. 9B, FIG. 9C, FIG. 9D (collectively referred to as FIG. 9) illustrate an example of an API call to an external server as part of the ACMS process.

FIG. 9A illustrates an API-based operation to initiate a patch deployment workflow across multiple systems. Specifically, this is a POST request being made to the endpoint/api/v2/job_templates/10/launch, which indicates the triggering of a predefined job template—such as part of an orchestration platform such as Ansible or AWX. The request may be configured to send a JSON payload under the Body tab using the raw format. The payload includes an extra_vars object that may dynamically pass key variables to the job execution context.

Within extra_vars, a list of hostnames is specified under the hostname key, representing the target systems (1nnn001a through 1nnn004a) that will receive the patch. The job_type is set to “linux_patch”, designating the specific category of change being implemented. The ctask field may correspond to a change task identifier from an external IT service management (ITSM) system, ensuring that this automated action is properly linked to a formal change record for tracking, approval, and/or audit purposes. Lastly, the MNE value, here shown as “NNN”, may be a mnemonic used to associate the job with a particular business unit, application, and/or operational context.

FIG. 9B illustrates a structured API request used to initiate a server decommissioning workflow. This is a POST request targeting the endpoint/api/v2/job_templates/10/launch, which may be responsible for launching a specific job template—such as defined within an automation framework such as Ansible or AWX. The request may use a JSON payload passed in the body, under the extra_vars object, to dynamically supply variables to the automation job at runtime.

The hostname array may list the fully qualified identifiers of the servers to be decommissioned (wnnn001ab through wnnn004ab), indicating that the job may be performed on multiple target systems. The job_type may be set to “decom_server”, which instructs the job template to carry out decommissioning operations such as data wiping, service shutdown, and/or removal from inventory systems. Additional flags may include precooldown set to false and postcooldown set to true, which may control whether to introduce system cool-down windows or waiting periods before or after job execution, such as to allow for graceful shutdowns or post-task validation.

The payload may also include fields to support integration with broader IT service management (ITSM) processes (e.g., as described herein). The ctask field may contain a task identifier that likely links this operation to an internal change or project task. The change_record and ctask_number fields, labeled “CHGnnnnnnnn” and “CTASKnnnnnn” respectively, associate this automation event with formal change control documentation, which may be crucial for compliance, traceability, and audit readiness.

FIG. 9C illustrates an API request used to initiate a targeted security remediation task within an enterprise environment. This POST request may be sent to the/api/v2/job_templates/10/launch endpoint, which launches a predefined job template, such as within an orchestration platform such as Ansible or AWX. The payload of the request may be a JSON object containing extra_vars, a structured set of runtime variables that define the scope and context of the job being executed.

As shown, the hostname field may identify a single server (1nnn001a) as the target of the operation. The job_type is specified as “linux_cis_remediation”, indicating that the task will enforce or remediate configurations according to the CIS (Center for Internet Security) Benchmark standards. The application value, “linux_cis_5_2_3_6”, may refer to a specific control or group of controls being addressed—in this case, potentially related to SSH or authentication settings defined in the CIS benchmark versioning scheme.

The payload may also include a ctask identifier, linking this automation event to a corresponding change task within an external IT service management (ITSM) system, ensuring traceability and/or governance. The mne field, “NNN”, may be a business unit or operational context tag used to classify or track the task internally.

FIG. 9D illustrates an API request used to automate a database maintenance task—specifically, the expansion of a database tablespace on a specified server. As shown there is a POST request to the/api/v2/job_templates/10/launch endpoint, indicating that a job template within an orchestration tool such as Ansible or AWX may be launched. The job may be initiated by passing a JSON payload with extra_vars, which are runtime variables required by the automation workflow.

The job_type may be defined as “snac_database_tablespace”, signaling that this job may carry out a database-related operation. The hostname provided is 1nnn001d, which identifies the target server where the tablespace resides. The snow_ci_name field (“database@1nnn001d”) may refer to a Configuration Item (CI) recorded in a ITSM CMDB (Configuration Management Database), allowing for a linkage between the change automation and the IT asset inventory. The ctask parameter, represented as a placeholder value, may connect this activity to an official change task in an external IT service management system to maintain traceability and ensure governance.

Additional variables may include tablespace_name set to “NNN” and space_to_add set to 9, indicating that the automation job will add 9 units (e.g., gigabytes, RAM, CPU, etc.) to the specified tablespace on the target database.

FIG. 9 (all figures in the aggregate) illustrates a series of structured API requests that show how an ACMS may be leveraged to perform a wide range of IT operations at scale in a consistent, auditable, and automated manner. Each request may launch a predefined job template—such as within an orchestration framework such as Ansible or AWX—by passing a set of contextual variables that define the scope, purpose, and/or targets of the operation. These may be generated by an AI agent or input from a user. These operations may include Linux patch deployments, server decommissioning, CIS security remediations, and/or database tablespace expansions (e.g., as described herein). The payloads may incorporate metadata such as hostnames, job types, change task identifiers (ctask), and other environment-specific details to enable proper execution and traceability. Such requests may work with external IT service management (ITSM) platforms (e.g., as described herein), configuration items, and/or compliance artifacts, ensuring that each automated action is linked to formal governance processes.

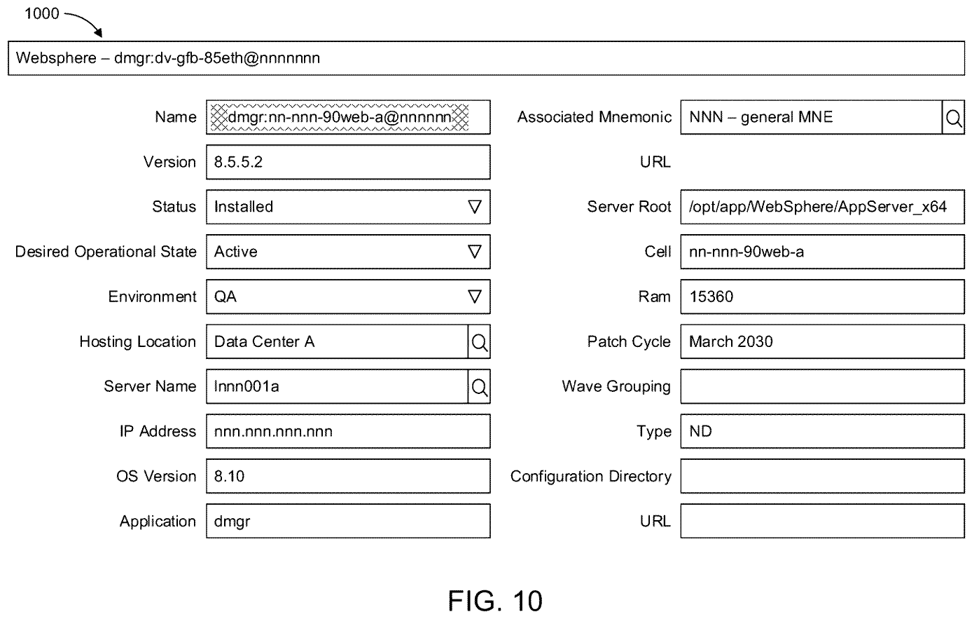

FIG. 10 illustrates an example form for detailed information for a change handled by an ACMS. As shown, there may be several fields, some of which may be required or optional. For example, the fields may include, but are not limited to, one or more of the following: name, version, status, desired operational state, environment, hosting location, server name, ET application, TCP ports, configuration, directory, associated mnemonic, URL, server, cell, ET version, ET Java version, DMG, admin, console port, application port, secure, application, port, allocated memory, processor allocation change, etc. What are more of the affirmation fields may be a drop-down menu, and/or a search field. In one instance, the input of information in one field may cause the automatic population of data into other fields. There may be pull down menus. Some fields may be restricted to the type of input that can be entered.

As shown in the example of FIG. 10, there is a detailed configuration record for a WebSphere Application Server instance, which may be managed as a configuration item (CI) within an enterprise IT service management or CMDB platform (e.g., as part of the ACMS). This record may provide metadata that may be referenced during automated change operations such as patching, configuration updates, or system remediation. A server is identified as dmgr:nn-nnn-90web-a@Innn001a, running WebSphere version 9.0.5.22, with a status of “Installed” and an operational state set to “Active.” It is located in “Data Center A” and assigned to the QA environment, indicating its role in non-production testing or staging.

Key technical attributes may include the server name (Innn001a), IP address placeholder, OS version (8.10), RAM allocation (15,360 MB), and/or the application (dmgr, referring to the deployment manager component of WebSphere). The configuration may also include file system paths, such as the server root (/opt/app/WebSphere/AppServer_x64), and cell name (nn-nnn-90web-a). The Associated Mnemonic field (NNN—General Mnemonic) may link this instance to an internal classification scheme or business unit, useful for organizing assets in ACMS operations. Patch cycle information (March 2030) suggests when this instance is scheduled for maintenance, which may trigger automation workflows. There may be other optional fields like Application URL, Console URL, and memory parameters (MinHeap, MaxHeap), and every field may not be filled for each record. In some instances, the record may contain sufficient information (e.g., not all fields are filled, or some fields are known, etc.) to be used by the ACMS.

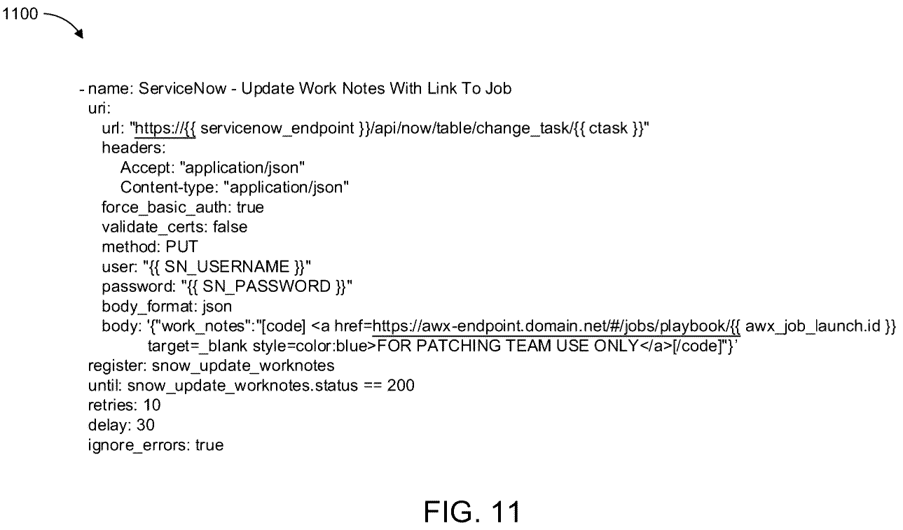

FIG. 11 illustrates and example of Ansible code that PUT calls ‘Comments’ from an external server to a service and/or sub-process of the ACMS. The code may include, but is not limited to, a name, URL, method, user, password, body format, body, etc. As shown, there may be an Ansible task that is used to update ServiceNow work notes with a link to a running job. The code shown demonstrates a PUT call—carried out against a ServiceNow endpoint via REST—that includes headers specifying JSON, a body containing the link text (“FOR PATCHING TEAM USE ONLY”), and credential fields for basic authentication. The name, URL, method, user, and password parameters define how and where the request is made, while the code uses a “register” statement (“snow_update_worknotes”) to capture the result and then repeats until it detects a successful (HTTP 200) response. In one case, this approach may be used early in the change-job workflow, but enabled “chatty” updates to ServiceNow work notes each time a job step completed. In another case, another approach may opt for a single API request at the beginning of the change process, ensuring ServiceNow work notes contain a link to the job without sending multiple incremental updates.

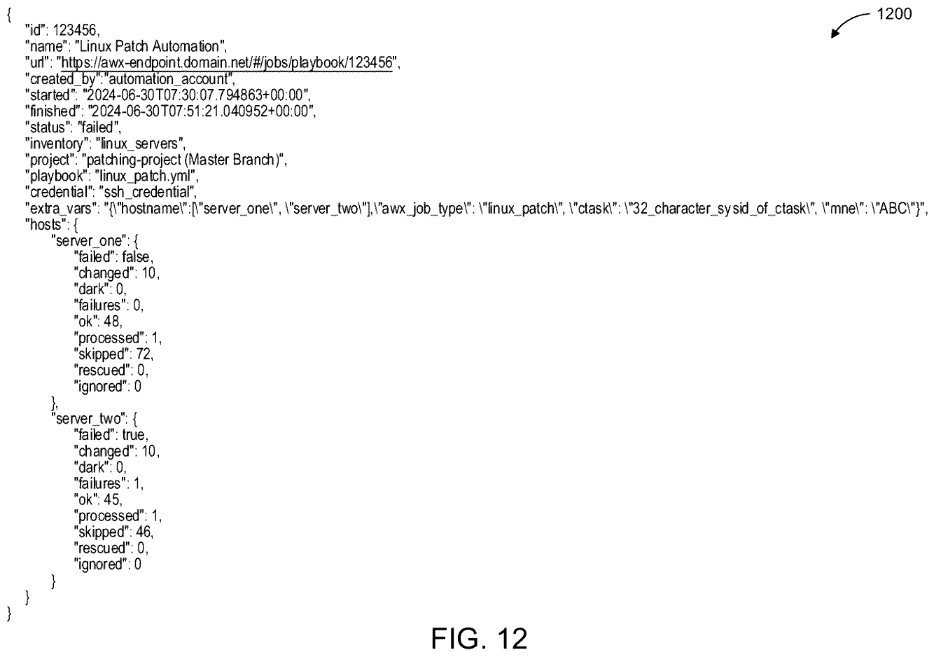

FIG. 12 illustrates an example JSON message from an orchestration/automation tool to ITSM of a job's failure. In the JSON example shown, AWX is reporting a failed job status back to ITSM. The message begins with overarching details about the job, such as its unique ID (123456), a descriptive name (“Linux Patch Automation”), and a URL leading to the job's playbook details in AWX. It also highlights the job's creation and start times, the inventory being used (e.g., “linux_servers”), the associated project (e.g., “patching_project”), and the credential reference. A “status” field is clearly set to “failed,” signifying the overall job outcome. Within the “extra_vars” section, the relevant execution parameters appear, including a list of the target servers (e.g., “server_one” and “server_two”) and a label for the job type (e.g., “linux_patch”).

The most revealing part of this payload shows the host-level results for each server: while “server_one” indicates no failures and no changes, “server_two” has at least one failed task. This discrepancy highlights the nature of the job failure; ITSM can parse this payload to identify which server(s) had errors, record the failed tasks, and display these results in its change or incident management workflows. Note, the failures: 1 on server_two. If any server in the list of servers (“hosts”) fails the job, this type of message may get sent back to a ITSM endpoint. When ITSM receives the failure, a workflow may create an incident based on data provided in this JSON message.

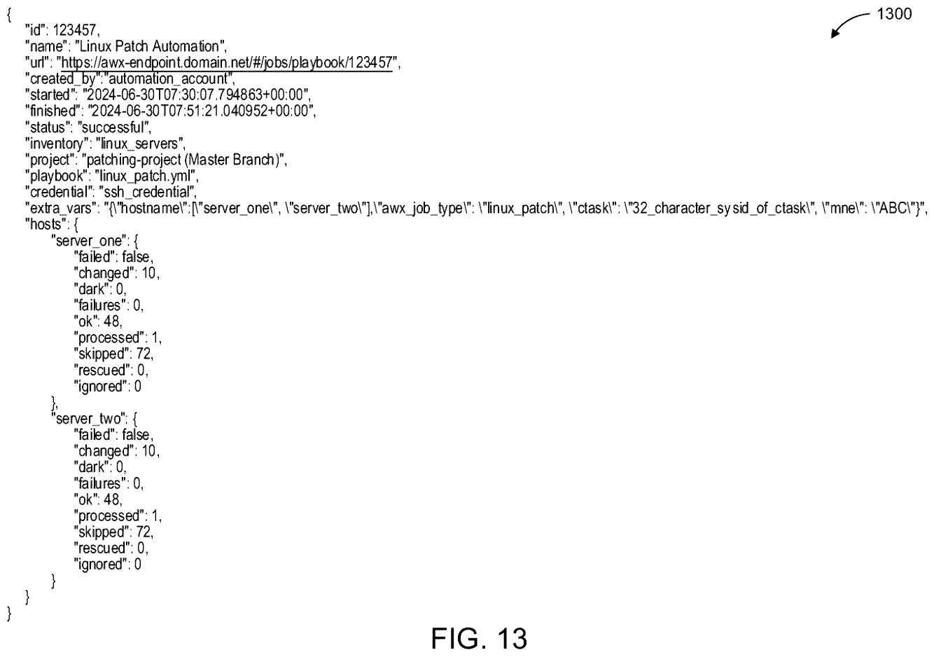

FIG. 13 illustrates an example JSON message from an orchestration/automation tool to ITSM of a job's success. This JSON message illustrates AWX sending job-completion details back to ITSM, effectively serving as a “job success” notification. It begins with top-level metadata that identifies the AWX job (e.g., “123427”), provides a descriptive name for the job (e.g., “Linux Patch Automation”), includes a URL link to the job's details within the AWX interface, and records timestamps showing when the job was created and when it started execution. It also specifies which AWX inventory was used (e.g., “linux_servers”), the project associated with the playbooks or roles (e.g., “patching_project”), and the credentials or vault information AWX employed.

Following that, the message contains “extra_vars,” a JSON object that outlines critical parameters about the job: it lists the hostnames of the targeted servers (for instance, “server_one” and “server_two”), defines the type of job (e.g., “linux_patch”), and includes additional contextual variables such as “ctask” or “emv.” Finally, host-level results detail the outcome on each server, indicating whether any task failed or was changed, and displaying the final Ansible counters (e.g., “ok,” “failed,” “changed,” “rescued,” “ignored”). In this example, everything completed successfully, with no changes or failures on the two Linux servers involved. ITSM may then use this payload, often provided through a webhook or REST endpoint, to update its own records and reflect the successful completion status for each target.

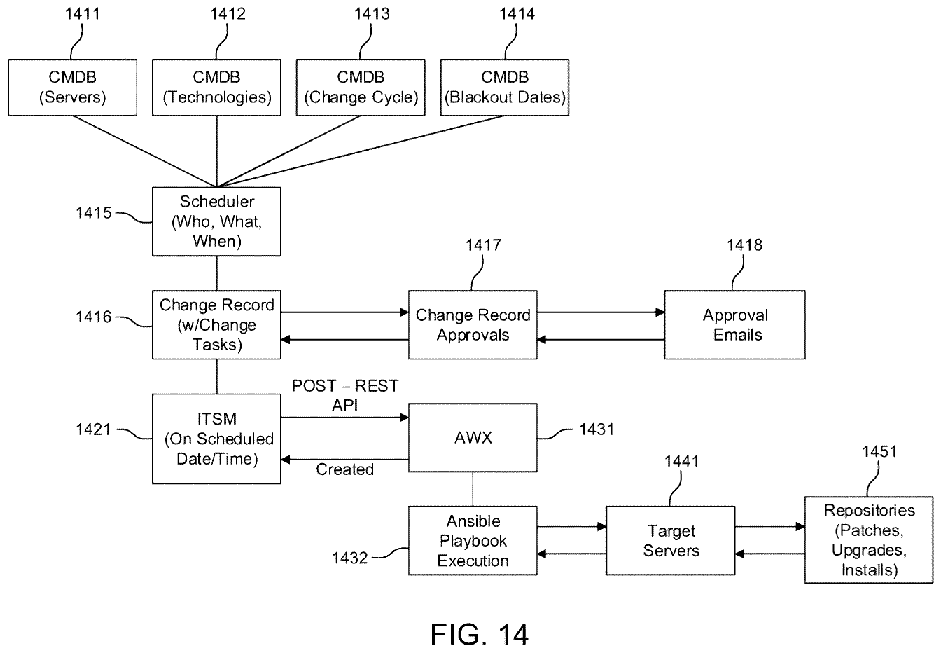

FIG. 14 illustrates an example of a flow diagram and hardware topology. In this example, a workflow is outlined: from identifying when patching is allowed (based on patch cycles and blackout dates) to scheduling changes in ITSM, obtaining approvals, calling AWX, and finally applying updates via Ansible to the target servers. Note, in one instance, certain elements may utilize the same underlying hardware. For example, functions/elements of: the CMDB, Scheduler, Change Record, and Change Record Approvals may operate from one hardware entity or set of resources; the ITSM (e.g., ServiceNow MidServer) may operate from one hardware entity or set of resources; the AWX and Ansible Playbook Execution may operate from one hardware entity or set of resources; the Target Servers may operate from one hardware entity or set of resources; and/or, the Repositories may operate from one hardware entity or set of resources. In another instance, each functions/element in FIG. 14 may share hardware resources. In one instance, each functions/element in FIG. 14 may not share hardware resources. In one instance, the entirety of the functions/elements/modules of FIG. 14 may be part of the ACMS.

Generally, data from the CMDB (e.g., servers, technologies, patch cycle, blackout dates) may feed into an automated scheduling and change-management process—ultimately driving Ansible playbook execution via AWX. As shown, there may be CMDB Inputs (1411, 1412, 1413, 1414): Servers (1411), which machines will be patched or changed; Technologies (1412), the type(s) of software/OS involved (e.g., Linux, Windows, Tomcat); Change Cycle (1413), used specifically for change/patch scheduling, following Microsoft's monthly “Patch Tuesday”; and/or, Blackout Dates (1414), days on which no patching or changes may be scheduled (e.g., holiday weekends).

The Scheduler (1415) may determine who will be patched/changed (e.g., the target servers), what the automated change is (e.g., patch, decommission, configuration, etc.), and when it should happen (date/time). For example, for a patch cycle, the scheduler ensures patching is only allowed from the second Wednesday after Patch Tuesday until the Sunday before the next Patch Tuesday, excluding any blackout dates.

For Change Record (1416) and Approvals (1417-1418), when the scheduler sets a plan, it creates a Change Record with associated tasks (1716). The record proceeds through an approval process (1417), generating approval communication (e.g., emails, etc.) (1418). Once approved, the system may proceed with the automated work.

For the ITSM (e.g., ServiceNow MidServer) (1421)→AWX (1431), on the scheduled date/time, a service manager (e.g., automation/orchestration, etc.) issues a REST API call (POST) to AWX. The JSON payload includes information about who to patch/configure and what tasks to run.

For the Ansible Playbook Execution (1432)→Target Servers (1441) and Repositories (1451), AWX acts as an Ansible automation hub. Jobs may be distributed across a cluster of AWX instances. Ansible Playbooks may then connect to the target servers (via SSH, WinRM, or REST), perform configuration changes, and if needed, retrieve patches or executables from repositories (1451).

In one example where a change is a patch, a ‘patch cycle’ may be defined by following Microsoft's “Patch Tuesday”; the second Tuesday of each month. Patching repositories update on “Patch Tuesday”. Patch scheduling is made available from 2nd Wednesday of each month until the Sunday before the next month's Patch Tuesday. For example, for the October 2024 patch cycle—patching repositories are updated on October 8th, servers can begin patching on October 9th and the last day of the cycle to patch would be Sunday November 10th. We reserve (prevent scheduling servers for patching) the Monday before Patch Tuesday for our own maintenance, and then the actual Patch Tuesday for updating of repositories. “Patch Cycle” is only applicable to patch scheduling. This may not apply to server decommission scheduling, or change automation scheduling.

For Blackout dates would be any dates we'd want to prevent people from scheduling their servers to be patched on. At one time we blocked off holiday weekends to prevent any patching/changes during long holiday weekends. We could also block off dates to limit changes in favor of promoting environment stability.

In one instance, Technologies (e.g., CMDB technologies) may be things like: Linux OS, Windows OS, Tomcat, Websphere, Apache, IBM MQ, etc.

In one instance, for the scheduler the who may refer to target servers, the what may refer to the automated change (patch, decommission, configuration, etc.), and the when may refer to date/time.

In one instance, at the AWX, this is a POST REST API call from ServiceNow MID Servers to Ansible AWX. The JSON payload contains the who and what.

In one instance, AWX may be a cluster of machines. Jobs may be spread across the cluster as they come in.

In one instance, Playbooks connect to targets via SSH, WinRM (windows remote management), and REST to make configuration changes. If applicable, targets will grab patches or update/install executables from repositories.

Generally, for an ACMS there may be one or more Configuration Management Databases (CMDB), that provide information into a central scheduler. The information may include, but is not limited to, servers, change types and associated required parameters, change cycles, blackout periods, and/or other relevant information as described herein. The scheduler may determine which changes to schedule, how they will be carried out, and/or whether/what additional approval/information may be needed. A change record may be created that includes details regarding the change request and/or the individual tasks involved in the change request. This record may proceed through an approval workflow and may trigger automated approval messages (e.g., emails, etc.) to notify stakeholders or approvers. Once approvals are granted (e.g., manually or automatically), an Information Technology Service Management (ITSM) platform may orchestrate the scheduled change execution. At the appointed date and time (e.g., exact time, time window, dynamically triggered time, etc.), an automation server (AWX) may receive an API call to launch a defined Ansible playbooks. These playbooks may reach out to target servers, retrieve the necessary patches, upgrades, change parameters, and/or installations from associated repositories, and apply the changes. Throughout this process, detailed logs are kept, along with data from the CMDB and the change record, which may enable compliance with established schedules, avoid blackout periods, and/or maintain an audit trail for the entire change process.

In some cases, AI may be integrated into the ACMS at various stages to enhance both operational efficiency (e.g., reduced run time, therefore reduced resource usage, etc.) and decision-making capabilities (e.g., enhanced functionality). For example, the ACMS may run AI-based risk assessment models that may analyze data from the CMDB, recent change histories, system performance metrics, and/or external threat intelligence feeds to predict the likelihood of a patch or configuration change resulting in an outage or security incident. These predictive models may dynamically adjust the scheduler's decisions (e.g., during a change workflow and/or as a recommendation prompting a change request, etc.), deferring potentially high-risk changes until mitigation steps have been taken, or routing such changes for additional approvals.

Additionally, the ACMS may run an AI-enabled anomaly detection model that may monitor post-change metrics and system logs (e.g., at intervals, real time, etc.), which may result in identifying irregularities that deviate from expected baseline behaviors. If the model detects an anomaly, it may trigger rollbacks or trigger a message to a user for immediate intervention.

Additionally, the ACMS may run a natural language processing (NLP) techniques to parse change requests from non-technical teams that would be processed and then used as the basis for filling out initial form data for a change request. The ACMS may also use NLP techniques to process logs, incident reports, etc. to automatically analyze, categorize and tag them for easier retrieval, and/or generate recommended action plans based on the analysis (e.g., patterns in the data).

In one example, there may be a method performed by an ACMS and/or one or more components, internal or external, which may provide an automated approach to managing and executing IT change requests, providing a change request interface, maintaining a configuration management database (CMDB), an automation engine, and/or a suite of notification and reporting mechanisms.

The method may begin with the receipt of a scheduling request via a change request interface, wherein the user specifies the type of change and a corresponding deployment schedule. Following this, the system may retrieve pertinent information from the CMDB and/or other sources, including, for example, the computing instances targeted by the change and any associated change bundles. A change record is may then be generated to formally document the request and track its progression through one or more change tasks. Before execution, the system may initiate an approval workflow to ensure the change is vetted appropriately.

Once approved, the change may be executed automatically via an automation engine, in accordance with the deployment schedule and the predefined change bundles. Post-execution, the system may validate the outcome of the change by monitoring or directly requesting completion information from the automation engine. This information may be subsequently used to update the change record, thereby maintaining a reliable and up-to-date audit trail.

To enforce governance, the method may also include logic for rejecting scheduling requests that conflict with preconfigured prevention parameters (e.g., blackout dates, etc.). For example, blackout periods may be determined by referencing restricted scheduling data stored within the CMDB, helping to mitigate risk by preventing changes during sensitive or high-risk periods.

Stakeholder visibility may be enhanced by incorporating links to the change job execution records within stakeholder dashboards or information repositories. Additionally, the system may support multi-channel notifications—including email, text messaging, chat applications, and push notifications—to provide stakeholders with real-time updates regarding the status of change processes. In the method, this may be performed by either pushing information and/or storing and/or organizing information for users, with varying degrees of access associated with the information such that only privileged users may access the information.

Logging and reporting capabilities may be performed. The system may collect logs at any stage of the process and completion statuses from the automation engine, aggregates this data, and generate a final change report, and/or a series of reports at different stages, for storage and/or distribution. This functionality may support secondary auditing (e.g., user, AI agent, etc.).

In some cases, an AI chatbot or AI agent (e.g., part of or accessible by the system) may be integrated into the change method/processes described herein. For example, at the initial stage of a process—namely, the submission of a change request—an AI chatbot may serve as a conversational interface to a user. This interface may receive users input regarding change requests in natural language while guiding them through form completion, validating inputs, suggesting relevant templates, or auto-filling data based on historical submissions. An AI agent may evaluate deployment schedules against preconfigured organizational constraints. An AI agent may proactively check for blackout windows by referencing restricted scheduling dates. An AI agent may also interpret user input expressed in vague terms, such as “end of quarter” or “before next release,” and use predictive models to suggest alternative scheduling options that present lower operational risk.

During an approval phase, an AI agent may analyze previous change requests, assess risk scores, and identify system dependencies to recommend whether a request should be approved or flagged for further review. An AI agent may also dynamically identify the most appropriate approvers based on the specific systems affected. Once the change is deployed through the automation engine, an AI agent may monitor execution logs and employ anomaly detection techniques to identify irregularities or failures. An AI agent may then recommend rollbacks or corrective actions as needed, further reducing the need for manual oversight.

An AI chatbot may deliver proactive status updates through platforms such as Microsoft Teams, Slack, or email, and/or respond to queries like “What is the status of CR-2025-03?” or “Did the deployment fail?” by providing natural language summaries of change progress. In the reporting phase, the AI agent may automatically generate executive summaries of completed changes, highlight outcomes and issues, and suggest metadata tags to support long-term knowledge management.

AI agents may perform one or more other functions, such as providing natural language querying of change records, predictive risk scoring based on factors like change type and timing, and continuous learning from past successes, failures, approval patterns, and stakeholder feedback. In one instance, an AI agent may, at the authorization of a user with appropriate authority, autonomously approve and execute changes based on learned decision trees and policy-driven constraints.

Such integration of AI agents, bots, etc. may enhance speed through real-time interactions, increases accuracy with intelligent validation, and scales efficiently to support multiple users. AI agents may deliver actionable insights in an automated fashion with respect to a given change process, automate low-risk processes, and significantly improve the user experience by offering an intuitive and conversational interface.

In an example, a software patch may need to be distributed to a set of computing instances. The system (e.g., ACMS) architecture may comprise several interrelated components, such as a web-based change request interface, a configuration management database (CMDB), an AI service layer, an automation engine (e.g., Ansible, Puppet, or SCCM), a message queue (e.g., RabbitMQ or Kafka), monitoring/logging infrastructure, and/or a component described herein. Each component may operate either as a microservice deployed on a container orchestration platform (such as Kubernetes) or as a set of dedicated virtual machines managed within a hybrid cloud environment.

Initially, a user may initiate a change request through a web interface, specifying the nature of the patch and the desired deployment window. This input may be immediately routed to an AI service layer via RESTful API calls. The AI chatbot, for example, that is implemented using a natural language processing (NLP) model (e.g., GPT-based or BERT-based), may interact with the user to validate the request, extract structured data, and cross-reference previous changes to suggest improvements or detect inconsistencies. Concurrently, the AI agent may query the CMDB to identify the target computing instances by sending asynchronous requests to a CMDB API. The response includes metadata about each device, such as operating system versions, current patch level, system criticality, and maintenance windows.

In one case, the user may provide the input manually rather than interfacing with an AI.

Following validation, the system may perform a conflict-checking routine by comparing the requested deployment schedule against blackout periods stored in the CMDB. If a conflict is detected, the system may generate an alternative schedule based on predictive modeling that accounts for risk patterns learned from historical data. The system may then forward a refined change request, along with the proposed schedule and affected asset list, to a message queue to decouple the processing pipeline. An approval microservice may subscribe to the relevant message topic, retrieves the message, and use AI/configuration, etc. to classify the request's risk level. High-risk changes may be escalated to a user reviewers via a messaging protocol or a workflow tool (e.g., ITSM), while low-risk changes may be auto-approved based on predefined policies (e.g., AI confidence thresholds, preconfigured, etc.).

Once approved, the automation engine may subscribe to an execution queue and retrieve deployment instructions. The engine orchestrates patch installation tasks across the target computers by invoking remote execution agents (e.g., PowerShell scripts, shell scripts, etc.) through secure channels. As the tasks progress, logs and telemetry data may be continuously streamed to a monitoring service and stored in a time-series database. The system may consume these logs in real time, applying anomaly detection algorithms to identify potential failures, performance degradations, or security issues. Any detected anomalies trigger alerts that are sent to both the change manager and the incident response team via integrated communication channels such as Slack or Microsoft Teams.

After the deployment concludes, the automation engine may send a final status report—including success/failure metrics, per-instance completion times, and any encountered errors. In one case, a user reviews. In another case, an AI agent may review. The agent may aggregate the information, generate a summary report, and/or update a centralized change record. This report may also be indexed into a knowledge base to inform future decision-making. Optionally, the AI agent may recommend follow-up actions or classify the patching activity for regulatory reporting purposes.

In one or more embodiments and/or examples described herein, there may be a graphical user interface (GUI) that serves as part of the ACMS. The GUI and related features may streamline workflows where user interaction is required and reduce errors during the a change process. For example, in one case a GUI may provide dynamic options and validations. The GUI may dynamically generate an interface with one or more elements based on user inputs, permissions, and/or real-time data from repositories or databases. For instance, the GUI may present only valid options for change-related tasks that are presented to users, thereby minimizing the risk of errors as compared to a command line approach. For example, in one case the GUI may present guided workflows. A user may be guided through mandatory steps and/or input required for a change process. The GUI may prevent inapplicable and/or out-of-order input and may ensures compliance with policies. For example, in one case the GUI may dynamically provide notifications. The GUI may provide updates on the progress and status of a change process/operation (e.g., server resources reallocation, patch deployments, etc.). The GUI may also alert one or more users about permissions or warnings if an issue arises. For example, in one case a GUI may provide recommendations, analytics, and/or search functions to simplify tasks, such as selecting a target computer/server for change deployment or identifying software changes to include in a change. For example, in one case a GUI may be customizable for different users. Based on the user's role and/or permissions, the GUI elements may vary. Some users might see more detailed options or features, while others see streamlined interfaces tailored to their tasks. For example, a GUI may adapt its functionality based on a user's role and permissions, ensuring tailored access to features and information. For instance, developers may see interface elements that allow them to perform actions such as building and deploying changes, whereas support engineers might only have access to view changes in progress or report defects. Managers overseeing the pipeline may view high-level dashboards summarizing multiple change statuses, while administrators may see detailed options for accessing various deployment environments. Junior developers with restricted permissions may not see some elements, such as those for higher level users. Additionally, lead engineers responsible for prioritizing changes may be offered suggestions and analytics to streamline decision-making (e.g., AI generated, as described herein), such as recommendations on target stages or deployment environments. To further enhance usability, GUIs for individual users may dynamically display valid options for selections, minimizing confusion and errors. This level of customization may increase the efficiency and security of the ACMS, by reducing the processing power needed to monitor/retrieve/process/display information for a given user (e.g., since it would be less efficient and less secure if each user was presented all information and tools).

As described herein, reference to configuring/configure may mean that a message may be sent to a device that includes configuration instructions/information for the device, which configures the device for operating in a specific manner as indicated by the configuration instructions/information. In one instance, the device may provide feedback after having received a configuration message. In one instance, the device may request the message. In one instance, the message may be unrequested. In one instance, the message may be targeted (e.g., sent directly, and/or using a specific identifier) to a specific device or a group of devices.

As described herein, a higher/lower layer may refer to one or more layers in a protocol stack of a given device, or a specific sublayer within the protocol stack. The protocol stack may comprise of one or more layers in a device or a network node, where each layer may have one or more sublayers. Each layer/sublayer may be responsible for one or more functions. Each layer/sublayer may communicate with one or more of the other layers/sublayers, directly or indirectly. In some cases, these layers may be numbered. Any reference herein to a layer in conjunction with a process, device, or system refers to a layer that is higher than the layer of the process, device, or system. In some cases, reference to a higher layer herein may refer to a function or operation performed by one or more layers described herein. In some cases, reference to a higher layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, instances, cases, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere (e.g., a different figure).

The methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a transceiver for use in device and/or network node.

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’. As described herein, “at least one of” may be interchangeable with “one or more of”. As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

What is claimed:

1. A method, the method comprising:
receiving, via a change request interface, a scheduling request for a change request that specifies at least one change type and a deployment schedule;
retrieving, from a configuration management database, data identifying target computing instances for the change request and change bundles associated with the change request;
generating a change record associated with the change request, wherein the change record includes one or more change tasks to track the change;
sending a request for approval associated with the change record;
automatically executing, via an automation engine, a change process associated with the change request on the target computing instances, based on the change bundles and the deployment schedule;
validating an outcome of the change process by requesting or monitoring for completion information from the automation engine; and
updating the change record with the completion information.

2. The method of claim 1, further comprising: sending a rejection to the scheduling request based on the deployment schedule conflicting with preconfigured blackout dates determined by referencing a set of restricted scheduling dates from the configuration management database.

3. The method of claim 1, wherein: adding a link to a change job execution record of a stake holders dashboard or stake holders information repository.

4. The method of claim 1, further comprising: sending notifications through one or more communication channels selected from the group comprising of email, text message, chat application, or push notification, wherein the notifications include status an update of the change process.

5. The method of claim 1, further comprising: receiving, from the automation engine, logs information, wherein the log information includes a completion status corresponding to each computing instance; aggregating all completion statuses into a final change report; sending or storing the final change report.

6. A device comprising a non-transitory computer-readable medium storing computer-executable instructions that, when executed by a processor of the device operatively connected to the non-transitory computer-readable medium, causes an automated change management system (ACMS) to:
receive, via a change request interface of the ACMS, a scheduling request for a change request that specifies at least one change type and a deployment schedule;
retrieve, from a configuration management database of the ACMS, data identifying target computing instances for the change request and change bundles associated with the change request;
generate a change record associated with the change request, wherein the change record includes one or more change tasks to track the change;
send a request for approval associated with the change record;
automatically execute, via an automation engine of the ACMS, a change process associated with the change request on the target computing instances, based on the change bundles and the deployment schedule;
validate an outcome of the change process by requesting or monitoring for completion information from the automation engine; and
update the change record with the completion information.

7. The device of claim 6, the ACMS further caused to send a rejection to the scheduling request based on the deployment schedule conflicting with preconfigured blackout dates determined by referencing a set of restricted scheduling dates from the configuration management database.

8. The device of claim 6, wherein: adding a link to a change job execution record of a stake holders dashboard or stake holders information repository.

9. The device of claim 6, the ACMS further caused to send notifications through one or more communication channels selected from the group comprising of email, text message, chat application, or push notification, wherein the notifications include status an update of the change process.

10. The device of claim 6, further comprising: receiving, from the automation engine, logs information, wherein the log information includes a completion status corresponding to each computing instance; aggregating all completion statuses into a final change report; sending or storing the final change report.
